(19) United States
(12) Patent Application Publication
(10) Pub. No.: US 2007/0116320 A1
(43) Pub. Date: May 24, 2007

(54) COMMUNICATION DEVICE

(75) Inventor: Ulin Ju, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/559,826

(22) Filed: Nov. 14, 2006

(30) Foreign Application Priority Data
Nov. 15, 2005 (TW) 94140052

(51) Int. Cl. H04R 25/00

(52) U.S. Cl. 381/380; 381/328

(57) ABSTRACT

A communication device is disclosed. The device includes a body and a speaker. The body includes a protrusion, and the speaker includes a track. The protrusion is movably received in the track for the speaker to move relatively to the body in an axial direction.

### BACKGROUND OF THE INVENTION

1. Field of the Invention

The invention relates to a communication device, and in particular, relates to a communication device comprising an extendable speaker.

2. Description of the Related Art

Communication device is a tool for transmitting voice, which can be carried around to play or receive sound signal. A communication device using Bluetooth technology (Bluetooth headset) can transmit sound signal in a wireless fashion. The communication device mainly comprises a speaker, a microphone, and a body. The speaker and the microphone are disposed on two ends of the body for playing and receiving sound.

The speaker of a conventional communication device protrudes out of the body, allowing insertion into ears to receive sound. However, the speaker cannot be stored conveniently when it is not in use because of the protruding speaker.

### BRIEF SUMMARY OF THE INVENTION

The invention provides a communication device comprising a body and a speaker. The body comprises a protrusion, and the speaker comprises a track. The protrusion is movably received in the track for the speaker to move relatively to the body in an axial direction.

The communication device further comprises an elastic member disposed between the body and the speaker. The elastic member provides elasticity, allowing the speaker to move relative to the body.

The track allows the speaker to move and rotate relative to the body in the axial direction.

The track comprises a first end and a curved portion. The protrusion is located at the curved portion when the speaker is in a first position, and the protrusion is located at the first end when the speaker is in a second position.

The track comprises a second end. The curved portion is between the first end and the second end. When the protrusion is located at the second end, the speaker is in a third position in the axial direction.

The third position is between the first position and the second position along the axial direction.

The communication device further comprises an elastic member disposed between the body and the speaker. The elastic member provides a force to move the speaker from the first position to the second position, or from the first position to the third position during the movement of the speaker.

The track forms L shape.

The track forms V shape.

The body comprises a first tube and the speaker comprises a second tube. The protrusion is formed on an inner surface of the first tube, and the track is formed on an outer surface of the second tube.

The communication device further comprises an elastic member disposed between the first tube and the second tube. The elastic member abuts the speaker so that the speaker moves from the first position to the second position.

The body comprises an upper case and a lower case, wherein the upper case has an opening. The first tube is disposed in the lower case, and the second tube of the speaker connects with the first tube through the opening.

The communication device further comprises a microphone disposed on the body. The communication device is a bluetooth headset.

The invention provides another communication device comprising a body, a speaker and a hinge mechanism. The hinge mechanism hinges to the body and the speaker for the speaker to rotate relatively to the body from a first position to a second position.

The hinge mechanism comprises a protrusion and a track. The protrusion moves in the track when the speaker rotates.

The hinge mechanism further comprises a first tube and a second tube. The first tube is integrally formed on the body, and the second tube is integrally formed on the speaker. The protrusion is disposed on the first tube and the track is disposed on the second tube.

The track comprises a curved portion, a first end and a second end. The speaker is in the first position when the protrusion is located at the curved portion. The speaker is in the second position when the protrusion is located at the first end. The speaker is in a third position, between the first position and the second position relative to the axial direction, when the protrusion is located at the second end.

The communication device further comprises an elastic member disposed between the first tube and the second tube. The elastic member abuts the speaker during the rotation of the speaker.

The communication device further comprises a microphone which is disposed on the body and the communication device is a Bluetooth headset.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a communication device of the invention;

FIG. 2A is a perspective view of the communication device, wherein the speaker is in the first position;

FIG. 2B is a perspective view showing a portion of the communication device in FIG. 2A;

FIG. 3A is a perspective view of the communication device;

FIG. 3B is a perspective view showing a portion of the communication device in FIG. 3A;

FIG. 4A is a perspective view of the communication device, wherein the speaker is in the second position;

FIG. 4B is a perspective view showing a portion of the communication device in FIG. 4A;

FIG. 5A is a perspective view of the communication device;

FIG. 5B is a perspective view showing a portion of the communication device in FIG. 5A;

FIG. 6A is a perspective view of the communication device, wherein the speaker is in the third position; and

FIG. 6B is a perspective view showing a portion of the communication device in FIG. 6A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

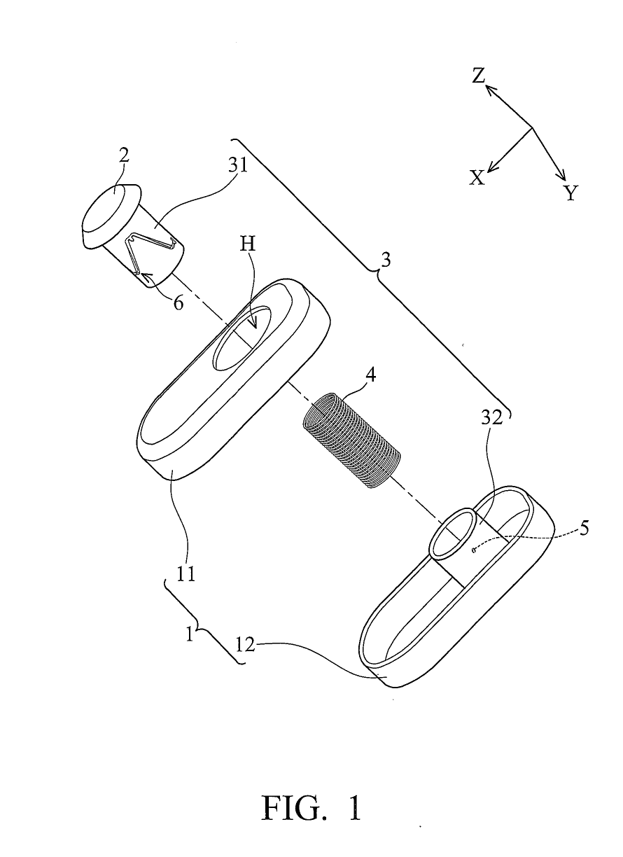

Referring to FIG. 1, the communication device, for example, a Bluetooth headset, comprises a body 1, a speaker 2, a hinge mechanism 3, an elastic member 4, a protrusion 5, and a track 6. The body 1 comprises an upper case 11 and a lower case 12, and the upper case 11 has an opening H. The hinge mechanism 3 comprises a first tube 31 and a second tube 32, wherein the first tube 31 and the speaker 2 are integrally formed in one piece, and the second tube 32 and the lower case 12 of the body 1 are integrally formed in one piece. The protrusion 5 is disposed on an inner wall of the second tube 32, and the track 6 is disposed on an outer wall of the first tube 31. During fabrication, the upper case 11 connects with the lower case 12, allowing the first tube 31 through the opening H of the upper case 11 to join with the second tube 32. The elastic member 4 is clamped by the first tube 31 and the second tube 32, wherein the outer wall of the first tube 31 attaches to the inner wall of the second tube 32, such that the protrusion 5 is movably received in the track 6. After completion of fabrication, the speaker 2 can rotate around the body 1 in an axial direction (axle Z), and move in the axial direction. Thus, the speaker 2 can move relative to the body 1 from a first position I to a second position II in the axial direction. When the speaker 2 rotates, the protrusion 5 moves in the track 6.

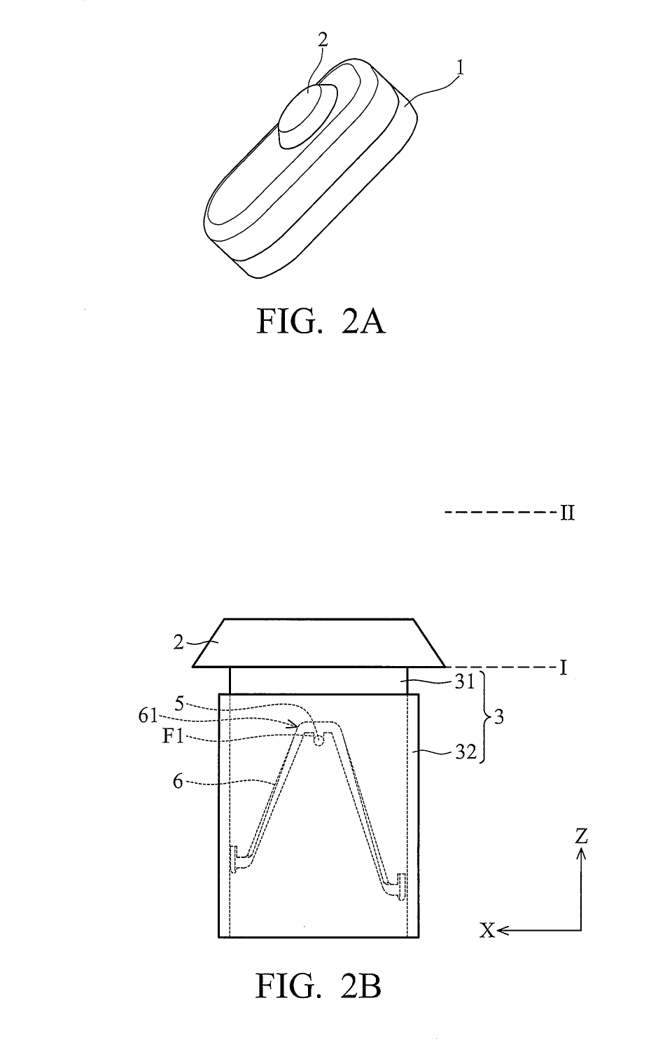

Referring to FIGS. 2A and 2B, when the communication device is not in use, a large portion of the speaker 2 is received inside the body 1. In detail, as shown in FIG. 2B, when the speaker 2 is in the first position I, the first tube 31 is wholly stored within the body 1, and the protrusion 5 is located at a curved portion 61. Further, the curved portion 61 has a first fixing portion F1. The elastic member 4 within the first tube 31 and the second tube 32 abuts the speaker 2; thus, the first tube 31 and the track 6 thereon are pushed up by the elasticity of the elastic member 4. As a result, the protrusion 5 can stay in the first fixing portion F1. It should be noted that the communication device in all figures is simplified; only the speaker 2, the first tube 31, the second tube 32, the protrusion 5, and the track 6 are shown.

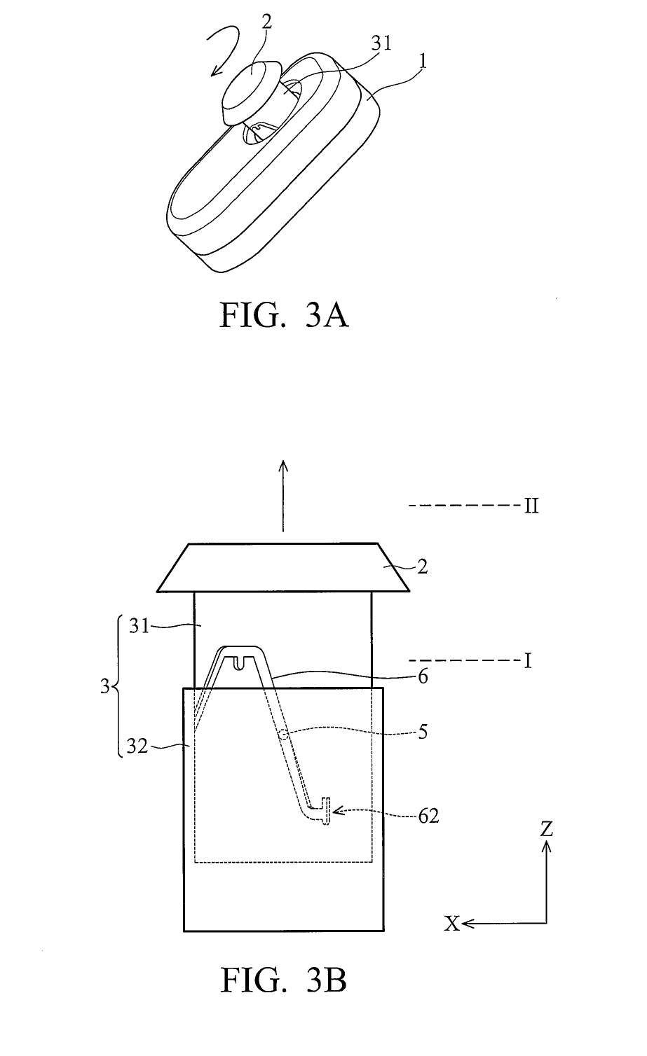

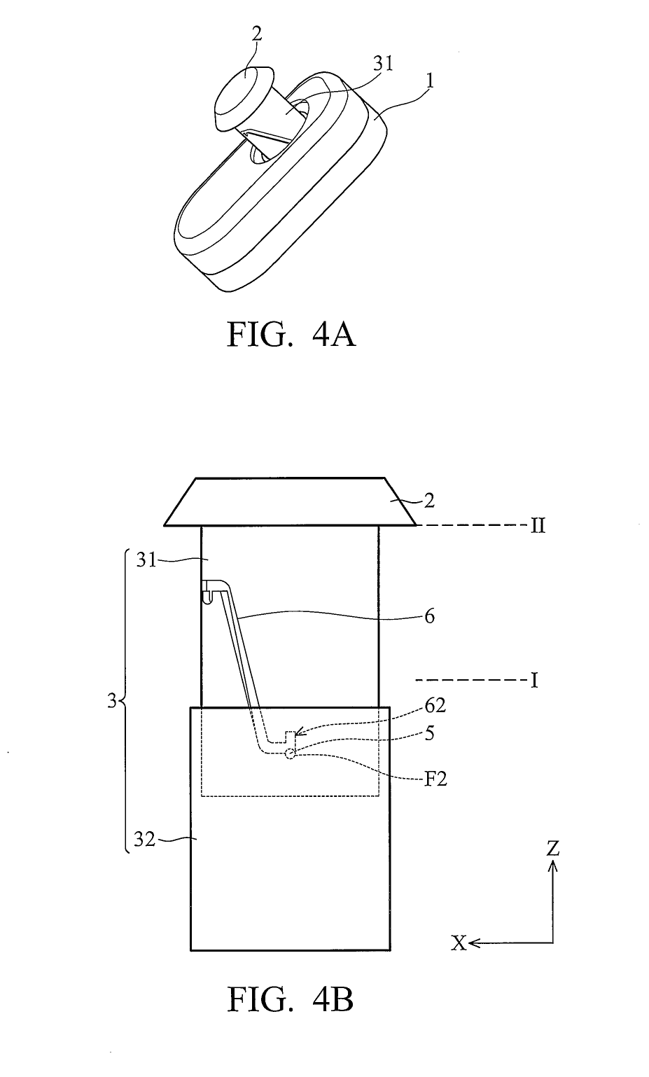

Referring to FIGS. 3A and 3B, to open the communication device, the speaker 2 is pushed down, allowing the protrusion 5 to separate from the fixing portion F1. Then, because the track at the curved portion 61 is horizontally disposed (as shown in FIG. 3A), the speaker 2 is turned clockwise, such that the first tube 31 can rotate along with the speaker 2. In other words, referring to FIG. 3B, the track 6 of the first tube 31 rotates relatively to the protrusion 5. Afterwards, because the elasticity of the elastic member 4 pushes the speaker 2 up, the track 6 is then continuously rotated relative to the protrusion 5. Referring to FIGS. 4A and 4B, the track 6 continuously rotates relatively to the protrusion 5 until the protrusion 5 reaches a first end 62 of the track 6. Furthermore, a second fixing portion F2 is disposed at the first end 62. The elastic member 4 pushes the speaker 2 up, allowing the protrusion 5 to stay in the second fixing portion F2. In the meantime, the speaker 2 moves from the first position I to the second position II, and protrudes out of the body 1 (as shown in FIG. 4A).

It's noted that the track 6 at the curved portion 61 is relatively horizontal, but it is not limited thereto. If the track 6 at the curved portion 61 is slanted, the speaker 2 starts to rotate once the speaker 2 has been pushed, allowing the protrusion 5 to depart the first fixing portion F1.

To close the communication device, the speaker 2 is pressed down, allowing the protrusion 5 to separate from the second fixing portion F2. Then, the speaker 2 is rotated counter-clockwise. The first tube 31 rotates along with the speaker 2, such that the track 6 of the first tube 31 can rotate relatively to the protrusion 5 until the protrusion 5 moves relative to the track 6 to the first fixing portion F1 of the curved portion 61 of the track 6, and the speaker 2 is back to the first position I from the second position II (as shown in FIGS. 2A and 2B).

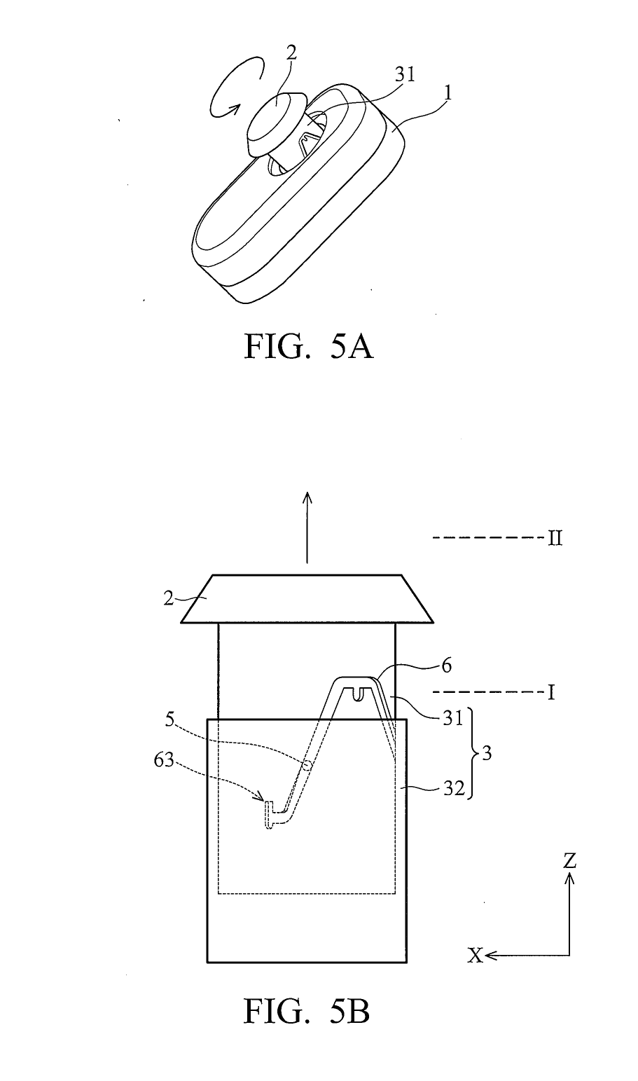

Otherwise, referring to FIGS. 5A and 5B, when the communication device is closed, the speaker 2 is pressed down, allowing the protrusion 5 to separate from the first fixing portion F1. Then, as shown in FIG. 5A, the speaker 2 is rotated counter-clockwise (in opposite direction as shown in FIGS. 3A and 3B). The first tube 31 rotates along with the speaker 2, such that the track 6 of the first tube 31 can rotate relative to the protrusion 5. Then, the elastic member 4 pushes the speaker 2 up; forcing the track 6 to continuously rotate relative to the protrusion 5.

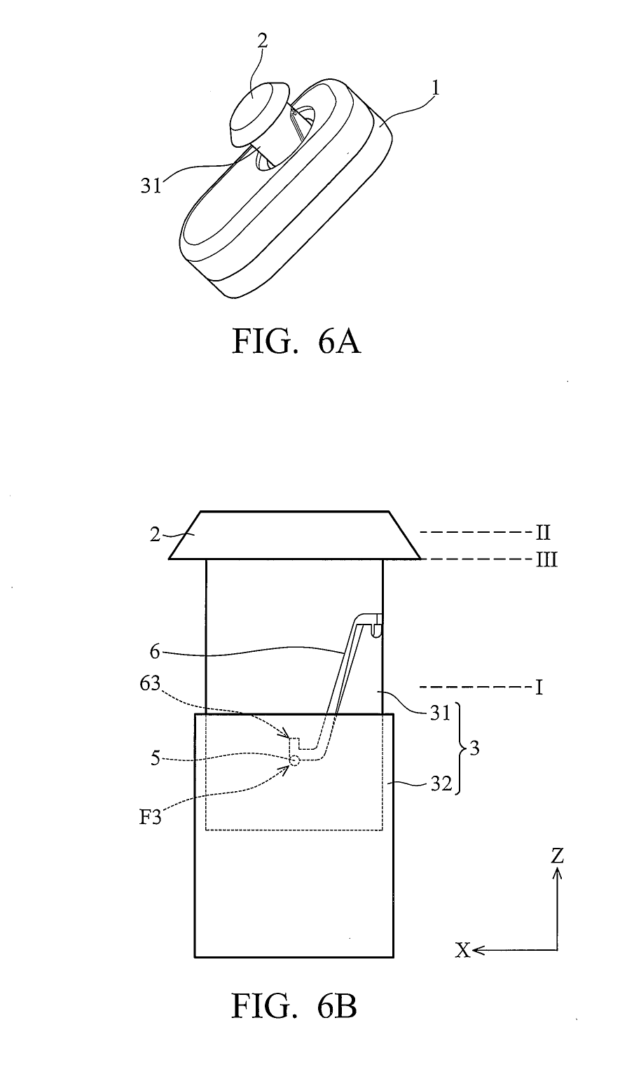

Referring to FIGS. 6A and 6B, the track 6 continuously rotates relative to the protrusion 5 until the protrusion 5 reaches a second end 63 of the track 6. Further, a third fixing portion F3 is disposed at the second end 63. The elastic member 4 pushes the speaker 2 up, allowing the protrusion 5 to stay in the third fixing portion F3. In the meantime, the speaker 2 moves from the first position I to the third position III, and protrudes out of the body 1 (as shown in FIG. 6A).

In conclusion, the speaker 2 rotates relative to the body 1 from a first position and a second position in the axial direction. In other words, the body 1 and the speaker 2 of the communication device are connected by the hinge mechanism 3. When the protrusion 5 of the hinge mechanism 3 is located at the curved portion 61 of the track 6, the speaker 2 is in the first position I. When the protrusion 5 is located at the first end 62 of the track 6, the speaker 2 is in the second position II. When the protrusion 5 is located at the second end 62 of the track 6, the speaker is in the third position III. That is, the hinge mechanism 3 allows the speaker 2 to rotate, and changes the relative position of the speaker 2 and the body 1.

In the above description, the first position I can be a closed position, the second position II can be an open position, and the third position III can be a middle position. That is, the position of the speaker 2 can be changed according to demand. Moreover, the disposition of the speaker 2 is not limited to the above positions. The speaker 2 can be designed in accordance with the track 6 to stay in any position.

The shape of the track 6 varies. For example, the track 6 is in an L shape, a V shape, or an irregular shape, providing the difference in height when the speaker 2 protrudes out of the body 1.

The elastic member 4 is a spring, providing elasticity for pushing the speaker up.

In the above description, the second tube 32, comprising the protrusion 5, connects with the body 1, and the first tube 31, comprising the track 6, connects with the speaker 2. However, the protrusion 5 and the track 6 can also change their disposition. Simply, the protrusion 5 can be disposed on the first tube 31, and the track 6 can be disposed on the second tube 32.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
a body comprising a protrusion; and
a speaker comprising a track;
wherein the protrusion is movably received in the track for the speaker to move relatively to the body in an axial direction.

2. The communication device as claimed in claim 1, further comprising an elastic member disposed between the body and the speaker, wherein the elastic member provides elasticity, allowing the speaker to move relative to the body.

3. The communication device as claimed in claim 1, wherein the track allows the speaker to move and rotate relatively to the body in the axial direction.

4. The communication device as claimed in claim 3, wherein the track comprises a first end and a curved portion, the protrusion is located at the curved portion when the speaker is in a first position, and the protrusion is located at the first end when the speaker is in a second position.

5. The communication device as claimed in claim 4, wherein the track further comprises a second end, the curved portion is between the first end and the second end, when the protrusion is located at the second end, the speaker is in a third position in the axial direction.

6. The communication device as claimed in claim 5, wherein the third position is between the first position and the second position along the axial direction.

7. The communication device as claimed in claim 5, further comprising an elastic member disposed between the body and the speaker, wherein the elastic member provides a force to move the speaker from the first position to the second position, or to move the speaker from the first position to the third position.

8. The communication device as claimed in claim 3, wherein the track forms L shape.

9. The communication device as claimed in claim 3, wherein the track forms V shape.

10. The communication device as claimed in claim 1, wherein the body comprises a first tube and the speaker comprises a second tube, the protrusion is formed on an inner surface of the first tube, and the track is formed on an outer surface of the second tube.

11. The communication device as claimed in claim 10, further comprising an elastic member, disposed between the first tube and the second tube, wherein the elastic member abuts the speaker so that the speaker moves from the first position to the second position

12. The communication device as claimed in claim 10, wherein the body comprises an upper case and a lower case, the upper case has an opening and the first tube is disposed in the lower case, and the second tube of the speaker connects with the first tube through the opening.

13. The communication device as claimed in claim 1, further comprising a microphone disposed on the body.

14. The communication device as claimed in claim 1, wherein the communication device is a Bluetooth headset.

15. A communication device, comprising:
a body;
a speaker; and
a hinge mechanism, hinged to the body and the speaker, for speaker to rotate relatively to the body from a first position to a second position.

16. The communication device as claimed in claim 15, wherein the hinge mechanism comprises a protrusion and a track, and the protrusion moves in the track when the speaker rotates.

17. The communication device as claimed in claim 16, wherein the hinge mechanism further comprises a first tube and a second tube, and the first tube is integrally formed on the body and the second tube is integrally formed on the speaker, the protrusion is disposed on the first tube and the track is disposed on the second tube.

18. The communication device as claimed in claim 17, wherein the track comprises a curved portion, a first end and a second end, and the speaker is in the first position when the protrusion is located at the curved portion, the speaker is in the second position when the protrusion is located at the first end, and the speaker is in a third position, between the first position and the second position relative to an axial direction, when the protrusion is located at the second end.

19. The communication device as claimed in claim 18, further comprising an elastic member disposed between the first tube and the second tube, wherein the elastic member abuts the speaker during the rotation of the speaker.

20. The communication device as claimed in claim 19, further comprising a microphone disposed on the body, and the communication device is a Bluetooth headset.
